(19) United States
(12) Patent Application Publication
(10) Pub. No.: US 2011/0147551 A1
(43) Pub. Date: Jun. 23, 2011

(54) RAIL UNIT FOR MOUNTING WALL FURNITURE

(75) Inventors: Bruno RICHARD, Ste-Julie (CA); Yves SIMARD, Laval (CA)

(73) Assignee: PRODUITS FORESTIERS DIRECT INC., St-Hyacinthe (CA)

(21) Appl. No.: 12/646,761

(22) Filed: Dec. 23, 2009

(51) Int. Cl. F16M 13/02; B23P 17/04

(52) U.S. Cl. 248/222.14; 248/205.1; 29/428

(57) ABSTRACT

The present document describes a rail unit, used in forming a rail assembly, for installing horizontally on a wall and for hanging pieces of furniture thereon. The rail unit comprises: an elongated body having a mating surface for making contact to the wall and a supporting lip for hanging pieces of furniture thereon. The elongated body further has a first end and a second end. The rail unit further comprises a first connector located at the first end; and a second connector located at the second end. In use, the first connector of the rail unit mates with the second connector of another rail unit for engaging the rail unit and the other rail unit together to thereby form the rail assembly for installing horizontally on the wall.

### CROSS-REFERENCE TO RELATED APPLICATIONS

This application is the first disclosure relating to this subject matter.

### TECHNICAL FIELD

This description relates to the field of furniture. More particularly, this description relates support systems for hanging or attaching modular pieces of furniture on or to a wall.

### BACKGROUND

Cabinets, closets, cupboards, bookshelves, wardrobes, desks, chests of drawers, shoe pigeon holes, media setups are all examples of furniture that can be integrated in modular systems for hanging on a wall or walls. In such systems a continuous rail is horizontally installed on the wall and partitions are hung on the rail by hooks. Pieces of furniture are arranged between the partitions. Before installing such modular systems on a wall the length of the rail needs to be determined. The rail is then cut and horizontally installed on the wall at a given height. The precision with which this first step is performed determines how well the final product will work and how good it will the look.

The adjustment of the horizontal leveling and height of the rail is very difficult without specialized tools. The installer has to calculate the length of the rail according to the composition of the final product; he has to report the length on the rail and cut the rail with a metal saw. Then, he needs an assistant to put the cut rail horizontally on the wall at the given height. Afterwards, most steps in the installation of the furniture can be performed by a single person. Moreover, when hanging the partitions, the installer has to calculate and report on the rail the right position of the partitions. Such calculations, reports, cutting and unique need of assistant generates risk of errors, lost time and costs.

There is therefore a need for improved rail for modular wall system.

### SUMMARY

According to an aspect, there is provided a rail unit, used in forming a rail assembly, for installing horizontally on a wall and for hanging pieces of furniture thereon, the rail unit comprising: an elongated body having a mating surface for making contact to the wall and a supporting lip for hanging pieces of furniture thereon, the elongated body further having a first end and a second end; a first connector located at the first end; and a second connector located at the second end; wherein, in use, the first connector of the rail unit mates with the second connector of another rail unit for engaging the rail unit and the other rail unit together to thereby form the rail assembly for installing horizontally on the wall.

According to another aspect, there is provided a method for installing a rail assembly on a wall, the rail assembly comprising a series of rail units, the method comprising: installing a first rail unit on the wall such that the first rail unit is level; connecting a first end of a second rail unit to a second end of the first rail unit; securing the second end of the second rail unit on the wall such that the second rail unit is level, the first and second rail units forming the rail assembly installed horizontally on the wall.

According to another aspect, there is provided a rail unit, used in forming a rail assembly using a mating connector, for installing horizontally on a wall and for hanging pieces of furniture thereon, the rail unit comprising: an elongated body having a mating surface for making contact to the wall and a supporting lip for hanging pieces of furniture thereon, the elongated body further having a first end and a second end; a first connector located at the first end; and a second connector located at the second end; wherein, in use, the first connector of the rail unit mates with the mating connector, the mating connector also mates with the second connector of another rail unit for engaging the rail unit and the other rail unit together to thereby form the rail assembly for installing horizontally on the wall.

According to another aspect, there is provided a method for installing a rail assembly on a wall, the rail assembly comprising a series of rail units, the method comprising: installing a first rail unit on the wall such that the first rail unit is level, the installing of the first rail unit involving the installing of a mating connector on the wall at a second end of the first rail unit; connecting a first end of a second rail unit to the mating connector; securing the second end of the second rail unit on the wall such that the second rail unit is level, the first and second rail units forming the rail assembly installed horizontally on the wall.

### BRIEF DESCRIPTION OF THE DRAWINGS

Further features and advantages will become apparent from the following detailed description, taken in combination with the appended drawings, in which:

FIG. 1 is a perspective view of a rail unit in accordance with an embodiment;

FIG. 2 is an end view of the rail unit of FIG. 1;

FIG. 3 is a perspective view of a wall and with multiple rail unit aligned for installation on the wall according to an embodiment;

FIG. 4 is a perspective cut out view of an upper left portion of a wall showing a first rail unit installed on the wall with a second rail unit being installed on the wall according to an embodiment;

FIG. 5 is perspective partial view of a wall showing the wall support structure and a series of rails unit installed on the wall according to an embodiment

FIG. 6 is a perspective view of a wall with a series of rail units installed and on which partitions are hung according to an embodiment;

FIG. 7 is a perspective view of the wall of FIG. 6 with furniture installed between the partitions; and

FIG. 8 is a flowchart showing a method for installing a rail assembly to a wall according to an embodiment.

It will be noted that throughout the appended drawings, like features are identified by like reference numerals.

### DETAILED DESCRIPTION

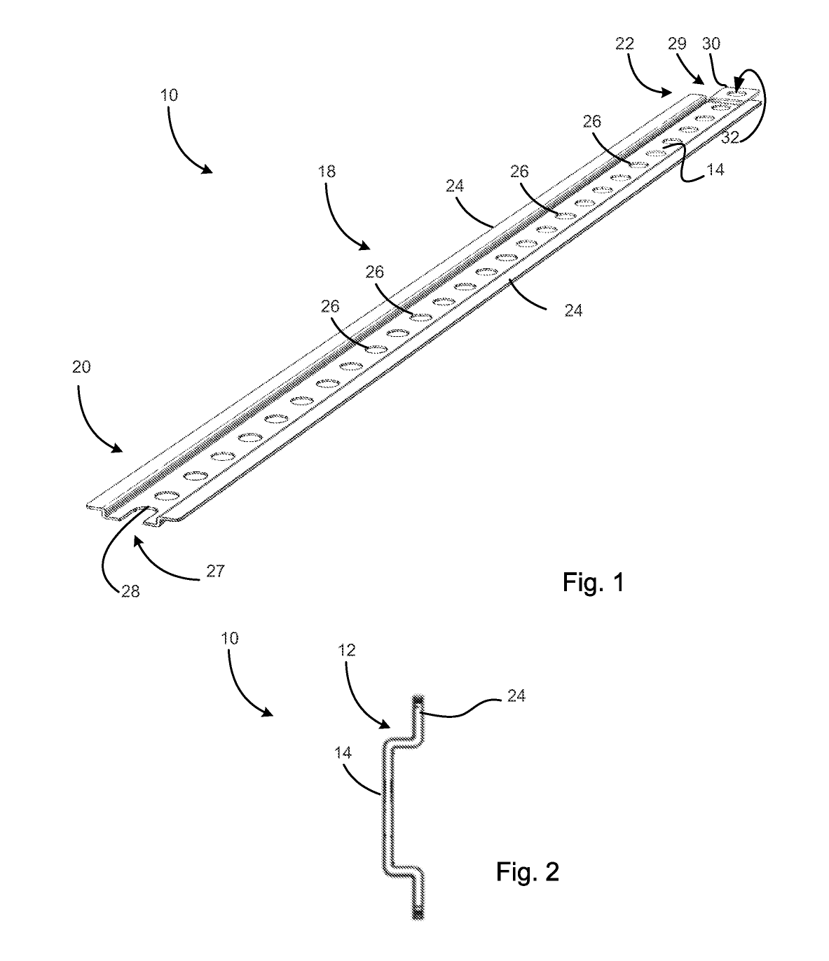

Referring now to the drawings, and more particularly to FIG. 1 and FIG. 2 concurrently referred to, there is shown a rail unit 10 for being horizontally installed on a wall and for hanging partitions thereon. The rail unit 10 is basically made from a steel profile, namely an elongated body, having a shape 12. The shape 12 comprises a mating surface 14 for making contact to a wall, not shown, on which the rail unit 10 is installed. The shape 12 further comprises a supporting lip 24 for hanging partitions thereon. The rail unit 10 comprises a central portion 18, a first end 20 and a second end 22. The shape 12 is optionally symmetrical and comprises a second supporting lip 24. The symmetry allows installing the rail unit 10 on the wall, indifferently the first end 20 on the right or on the left. The rail unit 10 further comprises a series of openings 26 through the mating surface 14. The series of openings 26 allows the passage of screws and/or anchors through selected openings located in front of studs located inside the wall for firmly squeezing the mating surface 14 of the rail unit 10 against the wall.

The rail unit 10 further comprises a first connector 27 located at the first end 20. According to an embodiment, the first connector 27 comprises a notch 28 in the steel profile proximate the mating surface 14. The notch 28 allows sliding on the steel profile between the wall and a screw head of a screw already screwed in the wall. The rail unit 10 further comprises a second connector 29 located at the second end 22. According to an embodiment, the second connector 29 is a lug 30 outwardly extending from the mating surface 14. The lug 30 is offset from the mating surface 14 (i.e., shifted away from the wall), so that the first end 20 of another rail unit, not shown, can slide between the wall and the lug 30 while a first rail unit such as rail unit 10 is installed on the wall. Moreover, the lug 30 comprises a lug opening 32 providing a passage for a screw.

According to another embodiment, a mating connector (not shown) can be used to connect/hold two rail units together. The mating connector comprises an opening to allow the passage of a screw and/or anchor for securing the mating connector to the wall. The mating connector also includes one or more mating portions which mate with a first and a second end of a respective rail unit.

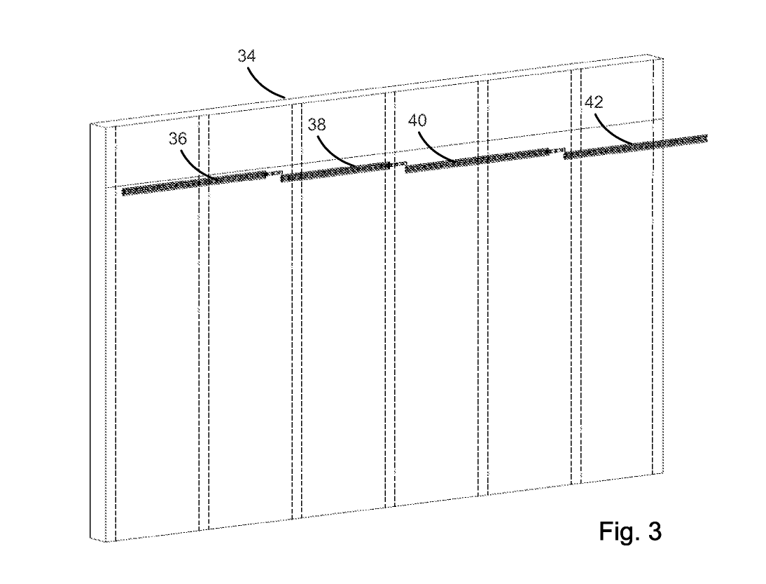

Now referring to FIG. 3, there is shown a wall 34 with rail units 36, 38, 40, 42 forming a rail assembly selected according to the composition of the final product and the length of the wall and ready to be installed on the wall 34. The rail units 36, 38, 40, 42 are made like the rail unit 10, but they may come in different lengths. The length of each rail unit is chosen from a list of standard lengths corresponding to standard registered widths between partitions. According to an embodiment, registered lengths are 18″, 24″, 27″, 30″ and 36″. A list of available pieces of furniture fitting with the width between partitions corresponds to each registered width.

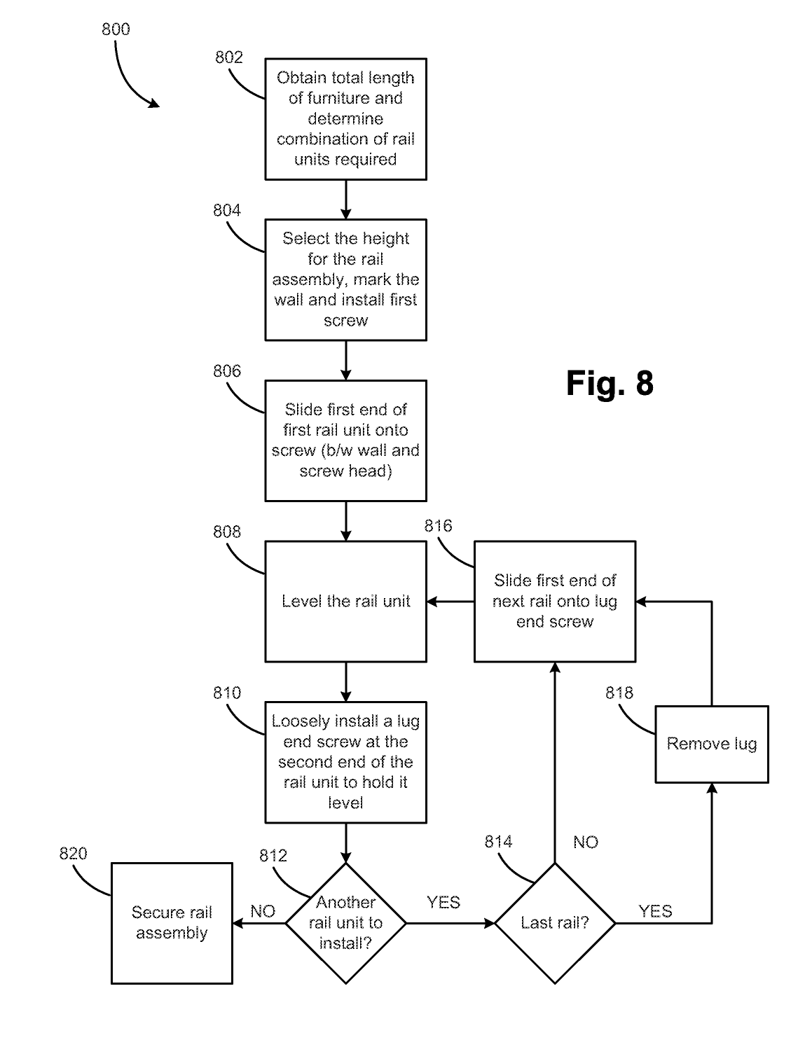

A method 800 for installing a rail assembly to a wall is described in reference to FIG. 8. At step 802, an installer obtains the total length of the furniture to be installed and determines the combination of registered lengths of rails units that will be required. The installer begins by installing a first rail unit 36 from the previously determined combination of rail units on the wall. At step 804, he selects the height at which the rail assembly should be mounted, marks the wall accordingly and installs a first screw 44 (i.e., a first support means which could also be or include an anchor) at the left part of the wall at the selected height. At step 806, he slides on the first end 20 of the first rail unit 36 between the wall 34 and the first screw 44. At step 808, he puts a level device on the first rail unit 36 and adjusts the height of the second end 22 such that the first rail unit 36 is level. At step 810, he loosely installs a lug end screw 46 in the wall and through the lug passage 32 of the second end 22.

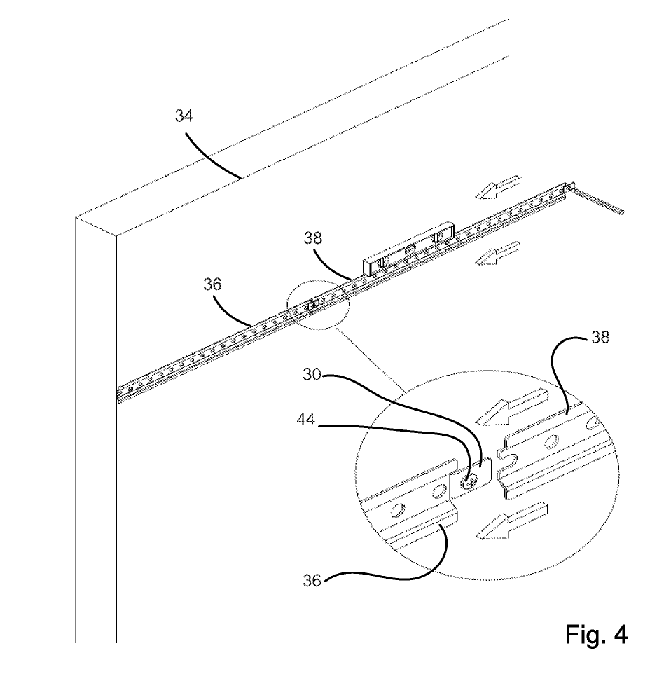

Now concurrently referring to FIG. 4 there is shown a connection of the first rail unit 36 and the second rail unit 38. Returning to FIG. 8, at step 812 the installer determines if there is another rail unit to install and, if so, which one from the previously determined combination will be installed. At step 814, the installer verifies if it is the last rail unit to be installed for completing the rail assembly. In this case, it is not and the installer then proceeds to install the second rail unit 38 to the wall 34. At step 816, he begins by sliding on the first end 20 of the second rail unit 38 between the lug 30 of the first rail unit 36 and the wall 34 thereby sliding the notch 28 on the lug end screw 46. The first connector of the second rail unit 38 mates with the second connector of the first rail unit 36 for engaging the first rail unit 36 and the second rail unit 38 together until they are secured later. The method then returns to steps 808 and 810 to complete the installation of the second rail unit 38.

The method will cycle through steps 812, 814, 816, 808 and 810 until the last rail unit is to be installed. In this example, the installer installs the third rail unit 40 and reaches step 814 for the fourth (and last) rail unit 42 (i.e., the last one of the rail units forming the rail assembly). This time step 814 identifies that the fourth rail unit is the last one to be installed. Therefore, before installing the rail unit 42, the installer cuts (or otherwise removes) the lug 30, for example, by bending it several times (step 818).

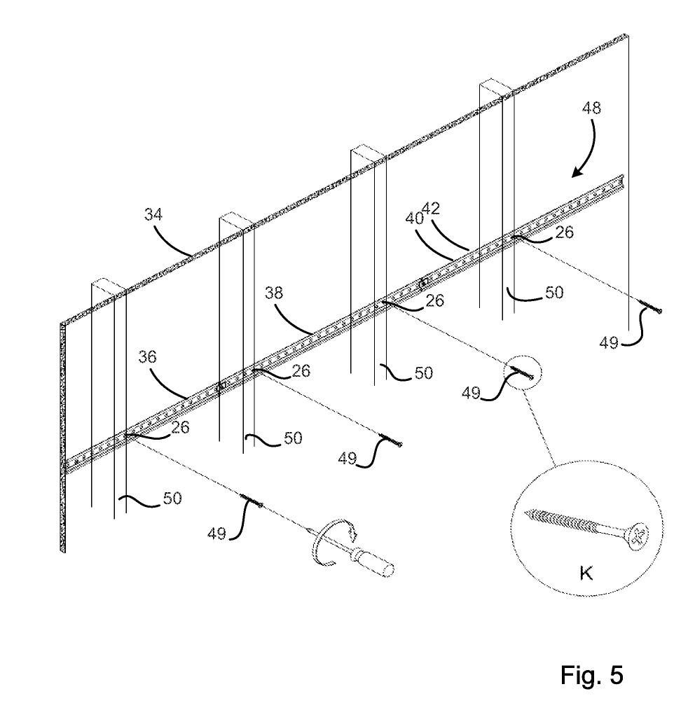

Referring now to FIG. 5, there is shown a rail assembly 48 installed on the wall 34. Returning to FIG. 8, once the method reaches step 812 one last time, it is determined that no other rail unit needs to be installed. The method proceeds to step 820, where the installer secures the rail assembly 48 by securely completing the screwing of previously installed loose screws and by installing screws 49, through selected openings 26 in corresponding studs 50 (which were previously identified) of the wall 34. Alternatively, in case where studs are difficult to find or the equipment for accurately finding them is not available, toggle bolts of the spring or snap type can be used.

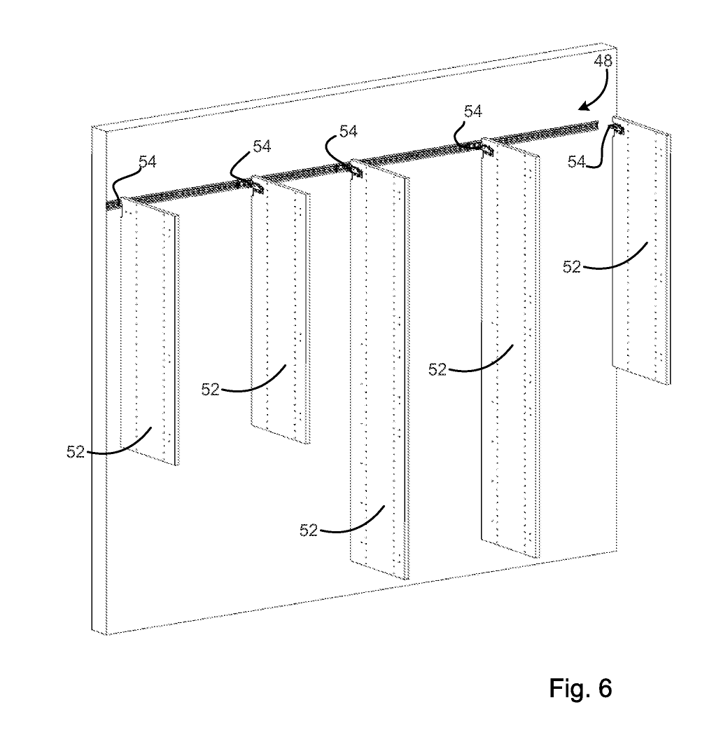

Referring now to FIG. 6, there is shown the rail assembly 48 installed on the wall 34 and partitions 52 hung to the rail assembly 48. To complete the installation and assembly of the furniture on the wall, the installer begins the assembly by hanging the partitions 52 to the rail assembly 48 using hooks 54 installed on the partition. The installer places all partitions 52 at the appropriate distance on the rail assembly 48. The installation of the different pieces of furniture between the partitions 52 serves to solidify the entire assembly.

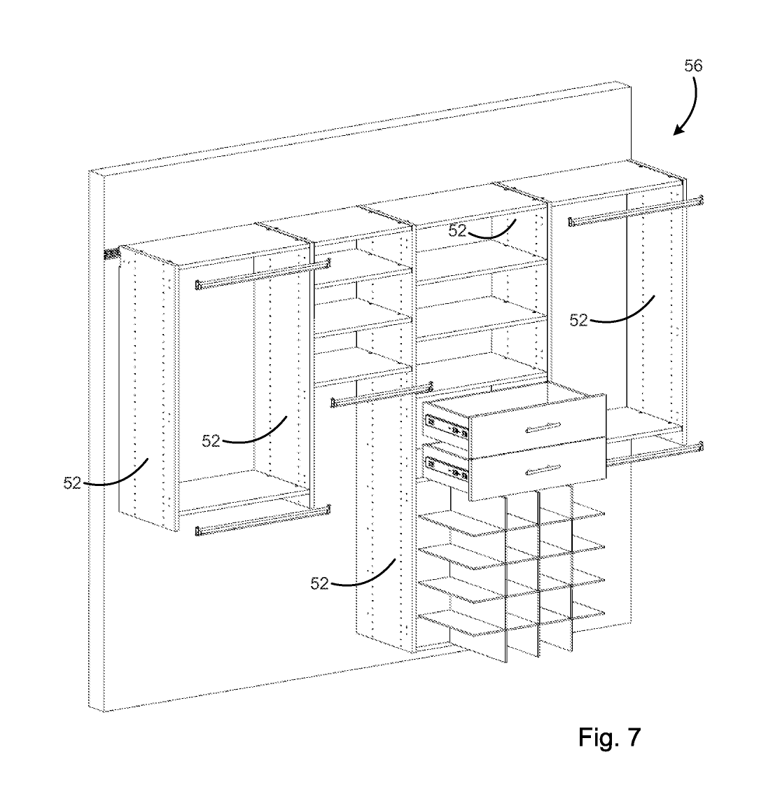

FIG. 7 shows a final product 56 completed with different pieces of furniture disposed between the partitions 52.

According to an embodiment of a method for installing a rail assembly in which a mating connector is used, the step of installing the first screw would be replaced by installing the mating connector. Also, the steps involving the lug end screw would be replaced by steps of installing/using the mating connector. Finally, the steps of determining if it is the last rails and removing the lug would probably not be required since the rail unit in this embodiment could do without a lug.

While preferred embodiments have been described above and illustrated in the accompanying drawings, it will be evident to those skilled in the art that modifications may be made therein without departing from the essence of this disclosure. Such modifications are considered as possible variants comprised in the scope of the disclosure.

1. A rail unit, used in forming a rail assembly, for installing horizontally on a wall and for hanging pieces of furniture thereon, the rail unit comprising:
an elongated body having a mating surface for making contact to the wall and a supporting lip for hanging pieces of furniture thereon, the elongated body further having a first end and a second end;
a first connector located at the first end; and
a second connector located at the second end;
wherein, in use, the first connector of the rail unit mates with the second connector of another rail unit for engaging the rail unit and the other rail unit together to thereby form the rail assembly for installing horizontally on the wall.

2. The rail unit of claim 1, wherein the first connector comprises a notch.

3. The rail unit of claim 1, wherein the second connector comprises a lug.

4. The rail unit of claim 3, wherein the lug is offset from the mating surface.

5. The rail unit of claim 1, wherein the elongated body further comprises a series of openings providing a passage of at least one of screws and anchors.

6. The rail unit of claim 1, wherein the supporting lip is longitudinal and has a length which is substantially the same as the mating surface.

7. The rail unit of claim 1, wherein the rail unit is longitudinally symmetrical.

8. The rail unit of claim 7, further comprising another supporting lip longitudinally opposite the supporting lip.

9. A method for installing a rail assembly on a wall, the rail assembly comprising a series of rail units, the method comprising:
installing a first rail unit on the wall such that the first rail unit is level;
connecting a first end of a second rail unit to a second end of the first rail unit;
securing the second end of the second rail unit on the wall such that the second rail unit is level, the first and second rail units forming the rail assembly installed horizontally on the wall.

10. The method of claim 9, wherein the rail units are of given registered lengths, the method further comprises, prior to installing the first rail unit on the wall, obtaining a total length of furniture to be installed using the rail assembly and determining from the total length a combination of rail units of given registered lengths that will accommodate the total length.

11. The method of claim 10, wherein the installing of the first rail unit comprises installing a first support means on the wall and sliding the first end of the first rail unit onto the first support means.

12. The method of claim 11, wherein the installing of the first rail unit comprises installing a second support means on the wall at the second end of the first rail unit.

13. The method of claim 12, wherein the connecting of the first end of the second rail unit to the second end of the first rail unit comprises sliding the first end of the second rail unit onto the second support means.

14. The method of claim 13, wherein the securing the second end of the second rail unit on the wall such that the second rail unit is level comprises installing a third support means on the wall at the second end of the second rail unit.

15. The method of claim 14, further comprising, prior to installing a last one of the rail units forming the rail assembly, removing a lug at the second end of the last one of the rail units.

16. A rail unit, used in forming a rail assembly using a mating connector, for installing horizontally on a wall and for hanging pieces of furniture thereon, the rail unit comprising:
an elongated body having a mating surface for making contact to the wall and a supporting lip for hanging pieces of furniture thereon, the elongated body further having a first end and a second end;
a first connector located at the first end; and
a second connector located at the second end;
wherein, in use, the first connector of the rail unit mates with the mating connector, the mating connector also mates with the second connector of another rail unit for engaging the rail unit and the other rail unit together to thereby form the rail assembly for installing horizontally on the wall.

17. A method for installing a rail assembly on a wall, the rail assembly comprising a series of rail units, the method comprising:
installing a first rail unit on the wall such that the first rail unit is level, the installing of the first rail unit involving the installing of a mating connector on the wall at a second end of the first rail unit;
connecting a first end of a second rail unit to the mating connector;
securing the second end of the second rail unit on the wall such that the second rail unit is level, the first and second rail units forming the rail assembly installed horizontally on the wall.
